(19) United States
(12) Patent Application Publication
(10) Pub. No.: US 2026/0122702 A1
(43) Pub. Date: Apr. 30, 2026

(54) METHOD AND APPARATUS FOR INITIAL BEAM PAIRING DURING UNICAST LINK ESTABLISHMENT IN SIDELINK COMMUNICATION

(71) Applicant: Intellectual Discovery Co., Ltd., Seoul (KR)

(72) Inventor: Hyuk Min SON, Seoul (KR)

(21) Appl. No.: 19/418,256

(22) Filed: Dec. 12, 2025

Related U.S. Application Data
(63) Continuation of application No. PCT/KR2024/008035, filed on Jun. 12, 2024.

(30) Foreign Application Priority Data
Jun. 12, 2023 (KR) 10-2023-0074759
Jun. 11, 2024 (KR) 10-2024-0075707

(51) Int. Cl. H04W 76/14; H04B 7/06

(52) U.S. Cl. CPC H04W 76/14; H04B 7/06954; H04B 7/06958

(57) ABSTRACT

Embodiments relate to a method and an apparatus for initial beam pairing during unicast link establishment in sidelink communication. A transmitting terminal according to one embodiment transmits a direct link establishment request (DCR) message to a receiving UE, and receives a direct link establishment accept (DCA) message from the receiving UE in response to the transmitted direct link establishment request message, wherein the direct link establishment request message is transmitted together with a reference signal (RS) for beam pairing, and wherein at least one of the direct link establishment request message and the direct link establishment accept message is repeated within a specific period.

### CROSS-REFERENCE TO RELATED APPLICATIONS

This application is a continuation application of PCT International Application No. PCT/KR2024/008035 filed on Jun. 12, 2024 and entitled “METHOD AND APPARATUS FOR INITIAL BEAM PAIRING DURING UNICAST LINK ESTABLISHMENT IN SIDELINK COMMUNICATION,” which claims priority to and the benefit of Korean Patent Application No. 10-2023-0074759, filed on Jun. 12, 2023, and Korean Patent Application No. 10-2024-0075707, filed on Jun. 11, 2024, the disclosures of which are incorporated herein by reference in their entireties.

### TECHNICAL FIELD

The present disclosure relates to 3GPP 5G sidelink communication.

### BACKGROUND ART

Sidelink (SL) refers to a method of performing direct communication between user equipments (UEs) by establishing a direct link therebetween without passing through a base station.

Vehicle-to-everything (V2X) refers to communication for exchanging information with other vehicles, pedestrians, infrastructure-enabled objects, and the like via a sidelink. That is, V2X may be classified into four types, such as vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

Meanwhile, as an increasing number of communication devices demand greater communication traffic over time, a next-generation 5G system, which is an enhanced wireless broadband communication system compared to the conventional LTE system, is required. In this next-generation 5G system, also referred to as NewRAT, communication scenarios are classified into Enhanced Mobile Broadband (eMBB), Ultra-Reliability and Low-Latency Communication (URLLC), Massive Machine-Type Communications (mMTC), and so on.

Here, eMBB is a next-generation mobile communication scenario that has characteristics such as High Spectrum Efficiency, High User Experienced Data Rate, and High Peak Data Rate. URLLC is a next-generation mobile communication scenario characterized by features such as Ultra Reliability, Ultra Low Latency, and Ultra High Availability (e.g., V2X, Emergency Service, Remote Control). mMTC is a next-generation mobile communication scenario characterized by features such as Low Cost, Low Energy, Short Packet, and Massive Connectivity (e.g., IoT).

### DISCLOSURE OF INVENTION

### Technical Problem

The present disclosure is to provide a method and an apparatus for initial beam pairing during unicast link establishment between terminals for sidelink communication in a wireless communication system.

### Solution to Problem

An embodiment of the present specification provides a method in which, in sidelink (SL) communication, a transmitting terminal transmits a direct link establishment request (DCR) message to a receiving terminal, and receives a direct link establishment accept (DCA) message from the receiving terminal in response to the transmitted direct link establishment request message, wherein the direct link establishment request message is transmitted together with a reference signal (RS) for beam pairing, and at least one of the direct link establishment request message and the direct link establishment accept message is repeated within a specific period.

Further, an embodiment of the present specification provides a method in which, in sidelink (SL) communication, a receiving terminal receives a direct link establishment request (DCR) message from a transmitting terminal, and transmits a direct link establishment accept (DCA) message to the transmitting terminal in response to the received direct link establishment request message, wherein the direct link establishment request message is received together with a reference signal (RS) for beam pairing, and at least one of the direct link establishment request message and the direct link establishment accept message is repeated within a specific period.

Further, an embodiment of the present specification provides a transmitting terminal for sidelink (SL) communication, comprising a control unit, and a memory unit storing instructions and being operably and electrically connectable to the control unit, wherein operations performed based on the instructions being executed by the control unit comprise: transmitting a direct link establishment request (DCR) message, and receiving a direct link establishment accept (DCA) message in response to the transmitted direct link establishment request message, wherein the direct link establishment request message is transmitted together with a reference signal (RS) for beam pairing, and at least one of the direct link establishment request message and the direct link establishment accept message is repeated within a specific period.

Further, an embodiment of the present specification provides a receiving terminal for sidelink (SL) communication, comprising a control unit, and a memory unit storing instructions and being operably and electrically connectable to the control unit, wherein operations performed based on the instructions being executed by the control unit comprise: receiving a direct link establishment request (DCR) message, and transmitting a direct link establishment accept (DCA) message in response to the received direct link establishment request message, wherein the direct link establishment request message is received together with a reference signal (RS) for beam pairing, and at least one of the direct link establishment request message and the direct link establishment accept message is repeated within a specific period.

Meanwhile, the transmitting terminal may receive beam reporting from the receiving terminal based on the transmitted reference signal. Furthermore, the transmitting terminal may transmit a beam pairing response to the receiving terminal, wherein the beam pairing response may be transmitted before receiving the direct link establishment accept message.

The beam reporting may be received based on a first specific time offset.

The direct link establishment accept message may be transmitted based on a second specific time offset.

The reference signal may be at least one of a sidelink synchronization signal block (S-SSB), a sidelink channel state information-reference signal (CSI-RS), and a demodulation reference signal (DM-RS) of a sidelink channel.

The reference signal may be repeatedly transmitted to the receiving terminal together with the direct link establishment request message within the specific period.

This specification describes technology targeting the 5G/5G-advanced system defined in 3GPP, but the techniques/concepts proposed in this specification may be applied to mobile communication systems other than 5G, such as LTE or a future 6G system.

### Advantageous Effects of Invention

According to the disclosure of the present specification, initial beam pairing and unicast link establishment for sidelink communication in the 3GPP 5G frequency range 2 (FR2) band can be performed efficiently.

### BRIEF DESCRIPTION OF DRAWINGS

FIG. 1 is a diagram illustrating an NR wireless communication system.

FIG. 2 illustrates a structure of a radio frame used in NR.

FIG. 3 illustrates a slot structure of an NR frame.

FIG. 4 illustrates an example of an NG-RAN architecture that supports a PC5 interface.

FIGS. 5A to 5B illustrate procedures for performing sidelink communication according to a sidelink resource allocation mode.

FIG. 6 is an example of signaling for performing initial beam pairing and unicast link establishment according to an embodiment of the present specification.

FIG. 7 illustrates an example of beam sweeping according to an embodiment of the present specification.

FIG. 8 illustrates an example of a sidelink slot configuration according to an embodiment of the present specification.

FIG. 9A and FIG. 9B illustrate examples of a DCR message and CSI-RS being transmitted within a beam sweeping period according to an embodiment of the present specification.

FIG. 10A and FIG. 10B are other examples of signaling for performing initial beam pairing and unicast link establishment according to an embodiment of the present specification.

FIG. 11 illustrates a wireless communication apparatus according to an embodiment of the present specification.

### MODE FOR THE INVENTION

Although embodiments are described herein using an LTE system, an LTE-A system, and an NR system, these embodiments may be applied to any communication system corresponding to the above definitions.

Furthermore, in the present specification, the term ‘base station’ may be used as a comprehensive term that includes a remote radio head (RRH), an eNB, a transmission point (TP), a reception point (RP), a relay, and the like.

3GPP-based communication standards define downlink physical channels corresponding to resource elements that carry information originating from a higher layer, and downlink physical signals corresponding to resource elements that are used by the physical layer but do not carry information originating from a higher layer. For example, the physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH) are defined as downlink physical channels, and a reference signal and a synchronization signal are defined as downlink physical signals. A reference signal (RS), also referred to as a pilot, means a predefined special waveform signal known to both a gNB and a UE. For example, cell-specific RS, UE-specific RS (UE-RS), positioning RS (PRS), and channel state information RS (CSI-RS) are defined as downlink reference signals. 3GPP LTE/LTE-A standards define uplink physical channels corresponding to resource elements that carry information originating from a higher layer, and uplink physical signals corresponding to resource elements that are used by the physical layer but do not carry information originating from a higher layer. For example, the physical uplink shared channel (PUSCH), physical uplink control channel (PUCCH), and physical random access channel (PRACH) are defined as uplink physical channels, and a demodulation reference signal (DMRS) for uplink control/data signals and a sounding reference signal (SRS) used for uplink channel measurement are defined.

In this specification, Physical Downlink Control Channel (PDCCH)/Physical Control Format Indicator Channel (PCFICH)/Physical Hybrid automatic retransmit request Indicator Channel (PHICH)/Physical Downlink Shared Channel (PDSCH) respectively mean a set of time-frequency resources or a set of resource elements carrying Downlink Control Information (DCI)/Control Format Indicator (CFI)/downlink ACKnowledgement/Negative ACK (ACK/NACK)/downlink data. Furthermore, Physical Uplink Control Channel (PUCCH)/Physical Uplink Shared Channel (PUSCH)/Physical Random Access Channel (PRACH) respectively mean a set of time-frequency resources or a set of resource elements carrying Uplink Control Information (UCI)/uplink data/random access signals.

Meanwhile, an NR frequency band may be defined with two types of frequency ranges (FR1 and FR2). The numerical values of the frequency ranges may be changed. For example, the two types of frequency ranges (FR1 and FR2) may be as shown in Table 1 below. For convenience of description, among the frequency ranges used in the NR system, FR1 may mean a “sub 6 GHz range”, and FR2 may mean an “above 6 GHz range” and may be called a millimeter wave (mmW).

TABLE 1

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

The numerical values of the frequency range of the NR system may be changed. For example, FR1 may include a band from 410 MHz to 7125 MHz as in Table 1. That is, FR1 may include a frequency band of 6 GHz (or 5850, 5900, 5925 MHz, etc.) or higher. For example, the frequency band of 6 GHz (or 5850, 5900, 5925 MHz, etc.) or higher included in FR1 may include an unlicensed band. The unlicensed band may be used for various purposes, for example, for communication for vehicles (e.g., autonomous driving).

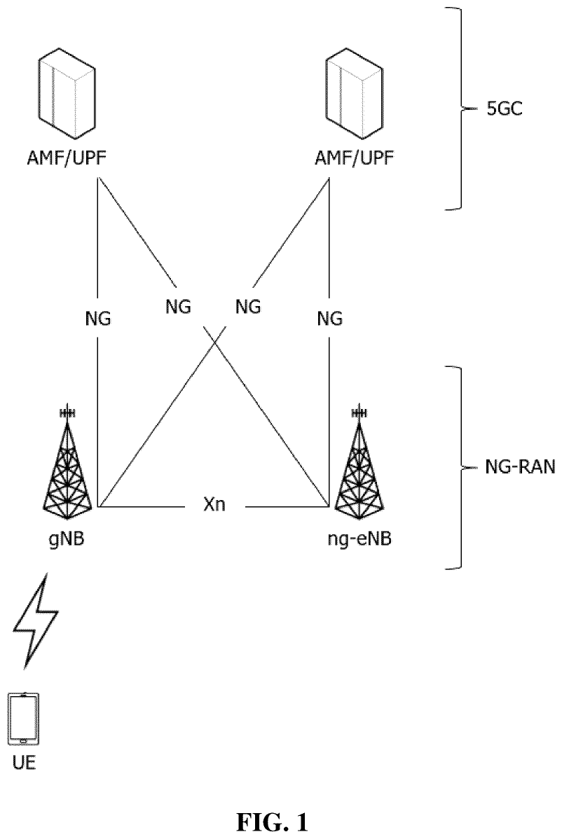

### FIG. 1 is a Diagram Illustrating an NR Wireless Communication System.

Referring to FIG. 1, the NR wireless communication system may be classified into a 5G core network (5GC) and a next generation-radio access network (NG-RAN), and the NG-RAN may include base stations (gNB and/or ng-eNB) that provide user plane and control plane protocol termination to a user equipment (UE). A gNB (next generation-Node B) provides NR user plane and control plane protocol termination to the UE, and an ng-eNB (next generation-evolved Node B) provides evolved-universal terrestrial radio access (E-UTRA) user plane and control plane protocol termination to the UE. The user equipment (UE) may be fixed or have mobility, and may be called by other terms such as mobile station (MS), user terminal (UT), subscriber station (SS), mobile terminal (MT), or wireless device. The base station (gNB and/or ng-eNB) may be a fixed station that communicates with the UE, and may be called by other terms such as base transceiver system (BTS), access point, etc.

The base stations (gNB and/or ng-eNB) may be connected to each other via an Xn interface, and may be connected to a 5G core network (5GC) via an NG interface. Specifically, the base stations (gNB and/or ng-eNB) may be connected to an access and mobility management function (AMF) via an NG-C interface, and may be connected to a user plane function (UPF) via an NG-U interface.

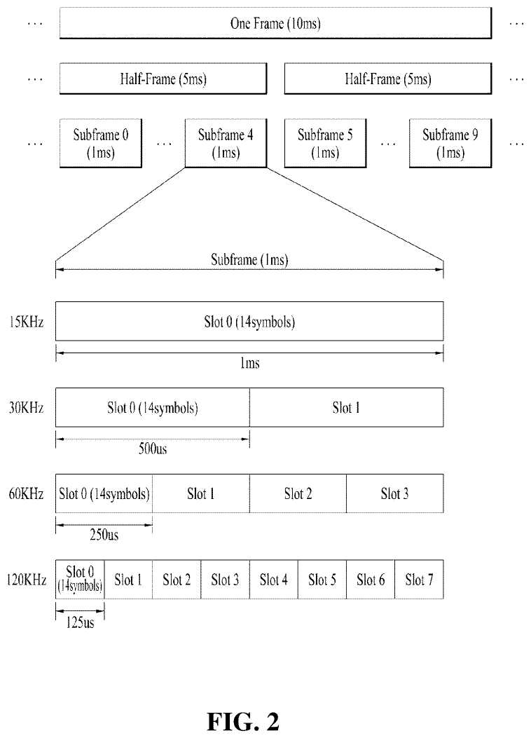

### FIG. 2 Illustrates a Structure of a Radio Frame Used in NR.

In NR, uplink and downlink transmissions are composed of frames. A radio frame has a length of 10 ms and is defined by two 5 ms Half-Frames (HFs). A half-frame is defined by five 1 ms subframes (SFs). A subframe is divided into one or more slots, and the number of slots within a subframe depends on the subcarrier spacing (SCS). Each slot includes 12 or 14 OFDM (A) symbols depending on the cyclic prefix (CP). In the case of normal CP, each slot includes 14 symbols. In the case of extended CP, each slot includes 12 symbols. Here, a symbol may include an OFDM symbol (or CP-OFDM symbol) or an SC-FDMA symbol (or DFT-s-OFDM symbol).

Table 2 illustrates that when normal CP is used, the number of symbols per slot, the number of slots per frame, and the number of slots per subframe vary depending on the SCS.

TABLE 2

| SCS(15*2^{u}) | N^{slot}_{symb} | N^{frame, u}ₛₗₒₜ | N^{subframe, u}ₛₗₒₜ |
|---|---|---|---|
| 15 KHz(u = 0) | 14 | 10 | 1 |
| 30 KHz(u = 1) | 14 | 20 | 2 |
| 60 KHz(u = 2) | 14 | 40 | 4 |
| 120 KHz(u = 3) | 14 | 80 | 8 |
| 240 KHz(u = 4) | 14 | 160 | 16 |

N^{slot}_{symb}: number of symbols in a slot
N^{frame, u}ₛₗₒₜ: number of slots in a frame
N^{subframe, u}ₛₗₒₜ: number of slots in a subframe

Table 3 illustrates that when extended CP is used, the number of symbols per slot, the number of slots per frame, and the number of slots per subframe vary depending on the SCS.

TABLE 3

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In an NR system, OFDM (A) numerology (e.g., SCS, CP length, etc.) may be set differently among a plurality of cells that are aggregated for a single UE. Accordingly, the (absolute time) duration of a time resource (e.g., SF, slot, or TTI) composed of the same number of symbols (collectively referred to as a Time Unit (TU) for convenience) may be set differently among the aggregated cells.

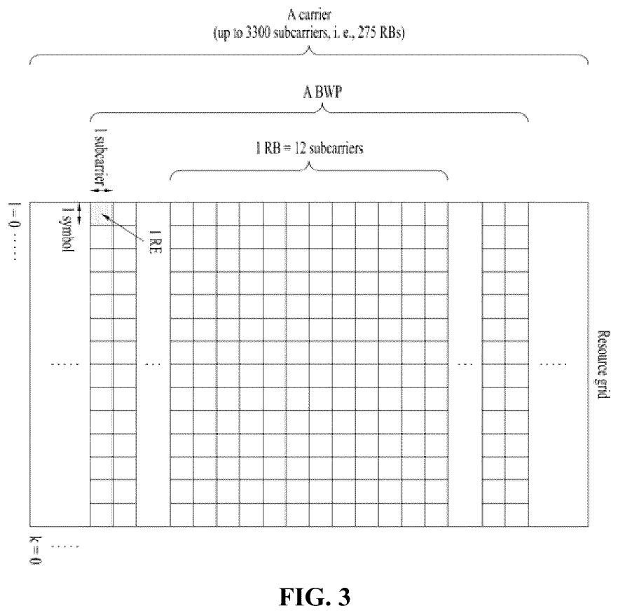

### FIG. 3 Illustrates a Slot Structure of an NR Frame.

A slot includes a plurality of symbols in the time domain. For example, in the case of normal CP, one slot includes 14 symbols, but in the case of extended CP, one slot includes 12 symbols. A carrier includes a plurality of subcarriers in the frequency domain. A resource block (RB) is defined by a plurality of (e.g., 12) consecutive subcarriers in the frequency domain. A bandwidth part (BWP) is defined by a plurality of consecutive (P)RBs in the frequency domain, and may correspond to one numerology (e.g., SCS, CP length, etc.). A carrier may include up to N (e.g., 4) BWPs. Data communication is performed through an activated BWP, and only one BWP may be activated for one UE. Each element in a resource grid is referred to as a Resource Element (RE), and one complex symbol may be mapped to it.

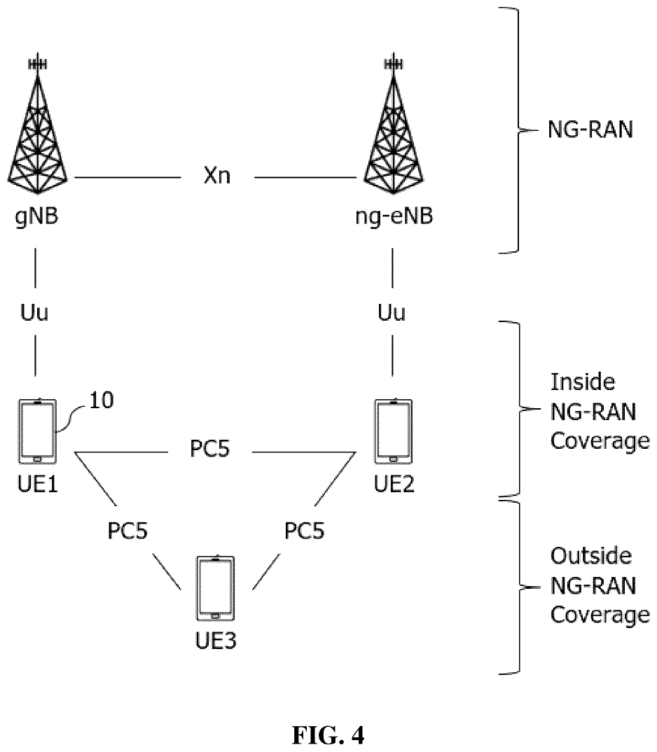

FIG. 4 Illustrates an Example of an NG-RAN Architecture that Supports a PC5 Interface.

Referring to FIG. 4, the next generation-radio access network (NG-RAN) architecture supports the PC5 interface. Sidelink transmission and reception via the PC5 interface are supported both when the user equipment (UE) is inside NG-RAN coverage and when the UE is outside NG-RAN coverage, regardless of the radio resource control (RRC) state of the UE.

Vehicle-to-Everything (V2X) service support via the PC5 interface may be provided by NR sidelink communication and/or V2X sidelink communication. NR sidelink communication may also be used to support services other than V2X services.

NR sidelink communication may support one type among a unicast transmission mode, a groupcast transmission mode, and a broadcast transmission mode. In the case of unicast type sidelink communication, a UE may perform one-to-one communication with another UE. In the case of groupcast type sidelink communication, a UE may perform sidelink communication with one or more UEs within a group to which it belongs.

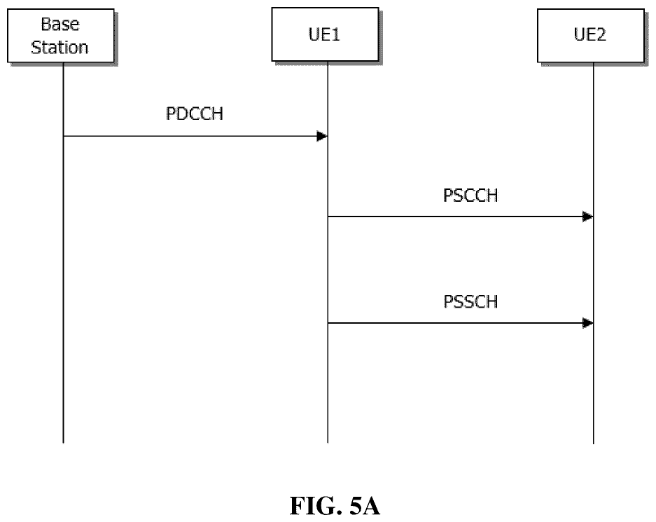

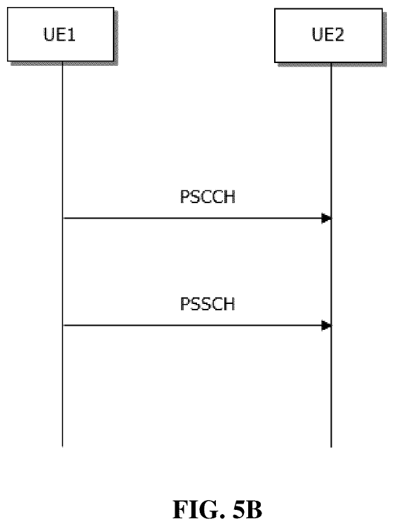

### FIGS. 5A to 5B Illustrate Procedures for Performing Sidelink Communication According to a Sidelink Resource Allocation Mode.

FIG. 5A illustrates a UE operation related to NR resource allocation mode 1, and FIG. 5b illustrates a UE operation related to NR resource allocation mode 2.

Referring to FIG. 5A, in NR resource allocation mode 1, a base station may schedule sidelink (SL) resources to be used by a user equipment (UE) for SL transmission. For example, the base station may perform resource scheduling for UE1 using a downlink control channel (DCI) transmitted via a physical downlink control channel (PDCCH), and UE1 may perform V2X or SL communication with UE2 according to the resource scheduling. For example, UE1 may transmit sidelink control information (SCI) to UE2 via the physical sidelink control channel (PSCCH), and then transmit SL data to UE2 via the physical sidelink shared channel (PSSCH) based on the SCI.

Referring to FIG. 5B, in NR resource allocation mode 2, a user equipment (UE) may determine a sidelink (SL) transmission resource within an SL resource configured by a base station or a pre-configured SL resource. For example, the configured SL resource or pre-configured SL resource may be a sidelink resource pool. For example, the UE may autonomously select or schedule a resource for SL transmission. That is, a UE may perform SL communication by autonomously selecting a resource within a configured resource pool. Furthermore, the UE may perform a sensing and resource (re) selection procedure to autonomously select a resource within a selection window. For example, the sensing may be performed on a sub-channel basis. As shown in FIG. 5B, UE1, which has autonomously selected a resource within the resource pool, may transmit SCI to UE2 via the PSCCH, and then transmit data based on the SCI to UE2 via the PSSCH.

Meanwhile, technology for performing initial beam pairing and unicast link establishment for sidelink communication in the frequency range 2 (FR2) band is currently under development. This specification proposes a procedure and detailed techniques for performing initial beam pairing before performing unicast link establishment. In particular, it proposes a reference signal (RS) and messages used for beam information delivery in the performance of the initial beam pairing operation, and a resource allocation method and/or operational method for transmitting the corresponding signal/data. Furthermore, when performing initial beam pairing before unicast link establishment, the receiving UE performs initial beam pairing without knowing whether the transmitting UE currently conducting the beam pairing procedure is the UE for unicast link establishment. Therefore, from the receiving UE's perspective, unnecessary beam pairing procedures may occur. This specification proposes a method for transmitting identifier information via a reference signal and message transmitted by a transmitting UE for initial beam pairing, in order to minimize the aforementioned unnecessary beam pairing procedures.

In 3GPP, discussions are underway regarding beam-related technologies for sidelink communication in the FR2 band, and Table 4 below shows a part of the related Agreements.

TABLE 4
Agreement (#112)
For sidelink beam management, RAN1 is to study
> how transmit beam(s) training and/or receive beam(s) training is performed
> whether and how spatial related information (e.g., TCI, QCL, beam ID, etc)
information could be identified
> the relationship between PC5 unicast link establishment and sidelink initial beam
pairing (e.g., whether initial beam pairing procedure starts before, during or after
sidelink unicast link establishment procedure.)
Agreement (#112b)
> RAN1 can study the following candidate procedure where initial beam pairing is
performed during sidelink unicast link establishment
> UE1 sends PSCCH/PSSCH that carries unicast link establishment message (e.g.,
DCR message) via different transmit beams
>> Note: multiple PSCCH/PSSCH transmissions (e.g., repetitions) from each of the
beams can be studied.
>> FFS: applicable reference signals which are transmitted together with unicast link
establishment message.
> if UE2 successfully decodes one (or more) of the PSCCH/PSSCH(s) and UE2
determines to establish a unicast link with UE1, it indicates to UE1 one (or more)
UE1 transmit beam(s) of PSCCH/PSSCH(s) which is successfully received
>> FFS details (e.g., implicit or explicit indication)
>> FFS: how to map between each PSCCH/PSSCH and UE1 transmit beam
>> FFS: how UE2 determines UE1 transmit beam(s) and/or UE2 transmit/receive
beam(s)
> UE1 uses one of the indicated beam(s) to finish the remaining sidelink unicast link
establishment procedure with UE2
>> FFS: how UE1 determines one of the indicated beam(s)
> FFS: use of additional reference signal or additional messages or additional
measurement for efficient beam pairing.
Agreement (#112b)
To study the feasibility of adapting S-SSB for initial beam pairing between UE1 and
UE2, at least the following can be considered.
> Whether/how to enable UE2 to identify UE1 (e.g., source ID) from UE1's S-SSB
transmission, to enable UE1 to identify the corresponding beam
measurement/reporting from UE2
> Mapping between S-SSB transmission/resource and beam related information
> Allocation of beam reporting resources respectively associated with different S-SSB
transmit beams
> Structure and contents of S-SSB
> Triggering and/or activation of S-SSB transmission, if needed
> Mechanism for S-SSB monitoring and reporting/responding
> Mechanism to mitigate/avoid the interference between overlapped S-SSB
transmissions from different UEs, including S-SSB transmission resources
> Potential impact to/from other UEs, and whether/how to avoid or mitigate this
impact
Agreement(#112b)
To study the feasibility of reusing SL CSI-RS for initial beam pairing, at least the
following enhancements can be considered.
> SL CSI-RS transmission with or without sidelink data transmission in the same slot
>> FFS: slot structure
> Mapping between SL CSI-RS transmission/resource and beam related information
> Periodic SL CSI-RS transmission, semi-persistent SL CSI-RS transmission, or
aperiodic SL CSI-RS transmission, with or without SCI indication
> Allocation of SL CSI-RS beam sweeping resources and if applicable, their
associated beam reporting resources
> Study the possibility to apply SL CSI-RS for initial beam pairing before, during or
after unicast link establishment
>> FFS: How to provide SL CSI-RS resource configuration
> Whether or how to mitigate/avoid the interference between overlapped SL CSI-RS
transmissions from different UEs
> SL CSI-RS transmission with or without repetition on transmit beams
Agreement (#113)
I In the candidate procedure where initial beam pairing is performed before sidelink
unicast link establishment,
> In step 1,
>> the applicable reference signal is selected based on
>>> Alt 1-1: S-SSB or its modified format
>>> Alt 1-2: standalone SL CSI-RS or its modified format
>>> Alt 1-3: non-standalone SL CSI-RS
>>>> Note: a transmission of standalone SL CSI-RS means that there is no
accompanying sidelink data (SL MAC SDU) transmission in the same slot. FFS:
Accompaniment of SCI(s) or SL MAC CE transmission or PSFCH.
>>> Alt 1-4: PSCCH/PSSCH DMRS
>> the reference signals are sent
>>> Alt 2-0: aperiodically
>>> Alt 2-1: periodically
>>> Alt 2-2: semi-persistent with activation and deactivation
>>>>FFS details of activation/deactivation
>> FFS resources and resource allocation of reference signal
>> FFS: if CSI-RS is used, whether UE1 transmits other information associated with
the CSI-RS
> In step 2,
>> UE1's transmit beam and UE2's receive beam are determined by UE2 as the pair
with the RSRP measurement satisfying certain condition(s)
>>> FFS details of condition(s)
>>> FFS explicit or implicit determination of UE1 transmit beam by UE2
>> a transmit beam of UE2 is at least determined as the one corresponding to
determined receive beam of UE2, at least if beam correspondence is assumed
>>> FFS other scheme
> In step 3,
>> UE2's beam reporting is associated with determined UE1's transmit beam.
>>> FFS details of association
>>> FFS details of beam reporting
>>> Note: this does not preclude beam reporting in the link establishment message.
>> FFS: how UE1 determines its transmit beam if it receives different beam reporting
from different UEs
> FFS: whether/how to avoid unnecessary beam measurement and reporting from
multiple UEs;
Agreement (#113)
In the candidate procedure where initial beam pairing is performed during sidelink
unicast link establishment,
> In step 1, the candidate reference signal which is transmitted together with unicast
link establishment message is selected based on one of the following alternatives
>> Alt 1-1: SL CSI-RS
>> Alt 1-2: PSCCH/PSSCH DMRS
> In step 2, UE2 determines UE1's transmit beam(s) and UE2's receive beam(s) as
the pair with the RSRP measurement satisfying certain condition(s).
>> a transmit beam of UE2 is at least determined as the one corresponding to
determined receive beam of UE2, at least if beam correspondence is assumed
>> FFS the format of UE1's transmit beam determined by UE2, e.g. implicit or
explicit
>> FFS details of condition(s)
> In step 2, UE2 indicates UE1's transmit beam(s).
>> FFS details of beam indication, including contents (e.g., ACK/NACK, beam ID,
RSRP measurement), container (e.g., PSCCH/PSSCH, PSFCH) and association (e.g.
resources)
> In step 3, UE1 determines UE1's transmit beam based on one or more of the
following alternatives
>> Alt 2-1: the latest beam indication
>> Alt 2-2: beam indication contents (e.g., RSRP measurement)
>> Alt 2-3: measurement/detection of beam indication signal

This specification proposes a communication method for the case where an initial beam pairing operation is performed together with unicast link establishment for sidelink (SL) communication. Preferably, it proposes an SL communication method for the case where an initial beam pairing operation is performed during a unicast link establishment procedure in the frequency range 2 (FR2) band.

In this specification, for convenience of description, UE1 is referred to as a UE that transmits data/signals in SL communication, and UE2 is referred to as a target UE that receives data/signals from UE1. Furthermore, a transmission beam used for data/signal transmission is referred to as a TX beam, and a reception beam used for data/signal reception is referred to as an RX beam.

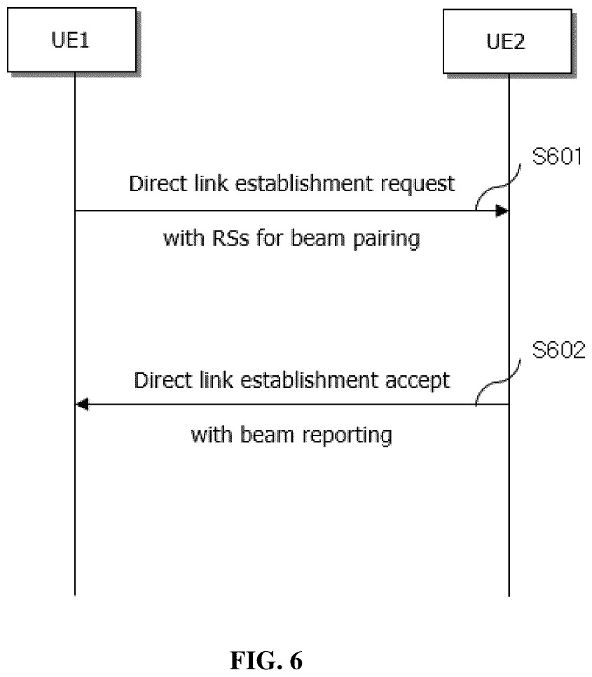

### FIG. 6 is an Example of Signaling for Performing Initial Beam Pairing and Unicast Link Establishment According to an Embodiment of the Present Specification.

The initial beam pairing in FIG. 6 is performed simultaneously through the process of performing unicast link establishment.

Referring to FIG. 6, UE1 transmits a direct link establishment request (DCR) message to UE2 (S601), and UE2 transmits a direct link establishment accept (DCA) message to UE1 (S602), thereby completing the unicast link establishment. Here, the DCR message may be transmitted together with other reference signals (RSs) in a beam sweeping manner (S601). UE2 may acquire beam information during the reception process of the DCR message and RSs, and based on the acquired beam information, transmit a DCA message including beam reporting for beam information transfer to UE1 using a specific beam or a specific resource (S602).

The DCR message of FIG. 6 may be transmitted in a beam sweeping manner within a beam sweeping period. At this time, the beam sweeping period may be indicated via a master information block (MIB), a system information block (SIB), and/or a radio resource control (RRC)/medium access control (MAC)-control element (CE), and may be configured and operated in an SL-specific or resource pool-specific form.

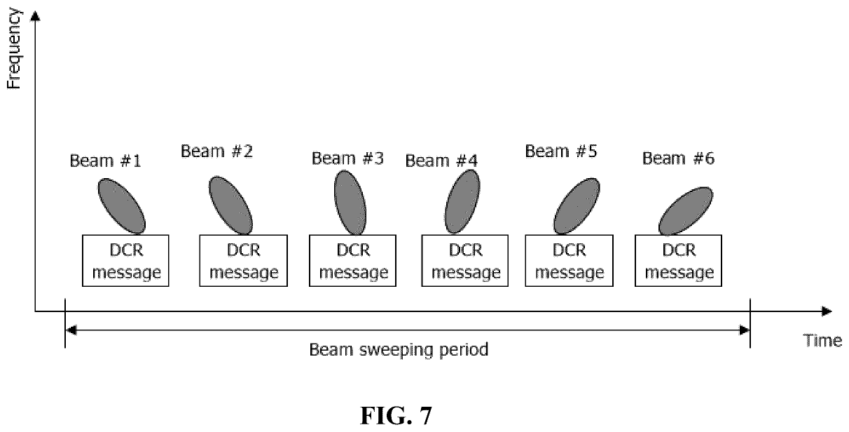

### FIG. 7 Illustrates an Example of Beam Sweeping According to an Embodiment of the Present Specification.

Referring to FIG. 7, an example is shown where a DCR message is transmitted in a beam sweeping manner via six beams during one beam sweeping period.

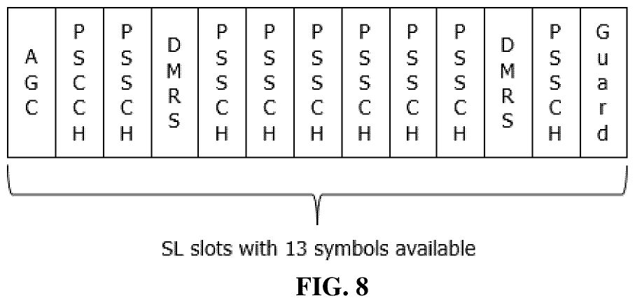

### FIG. 8 Illustrates an Example of a Sidelink Slot Configuration According to an Embodiment of the Present Specification.

FIG. 8 is an example of a single SL slot configuration when a DCR message is transmitted via one or more SL slots. Referring to FIG. 8, a slot composed of 13 symbols is composed of 1 automatic gain control (AGC) symbol, 1 PSCCH symbol, 8 PSSCH symbols, 1 guard symbol, and 2 demodulation-reference signal (DM-RS) symbols. In this SL slot, the number of PSSCH symbols and DM-RS symbols may be configured in various forms. Furthermore, it may also be configured in a form that includes a CSI-RS symbol.

A single SL slot may include an AGC symbol and a guard symbol, or a single SL slot may be composed only of a PSCCH and a DM-RS, or an SL slot may be composed only of a PSCCH and a CSI-RS, or may be composed only of a PSCCH and a PSSCH and a DM-RS, or may be composed only of a PSCCH and a PSSCH and a CSI-RS. At this time, in an SL slot composed only of a PSCCH and a CSI-RS and an SL slot composed only of a PSCCH and a PSSCH and a CSI-RS, a DM-RS for PSCCH and PSSCH decoding may be included.

In the example of FIG. 8, it was assumed that all RSs are transmitted with the same beam. Therefore, within a single SL slot, UE2 may change the receive beam for the same beam and perform measurement, and based on this, it is possible to acquire information about the transmit/receive beam pair for UE1 and UE2.

In the example of FIG. 8, some DM-RSs or some CSI-RSs transmitted within an SL slot may be transmitted with a different beam from the PSCCH, PSSCH, and the DM-RS for decoding the PSCCH and PSSCH. In this case, a UE (e.g., UE2) may perform measurement for a plurality of UE1 TX beams within a single SL slot.

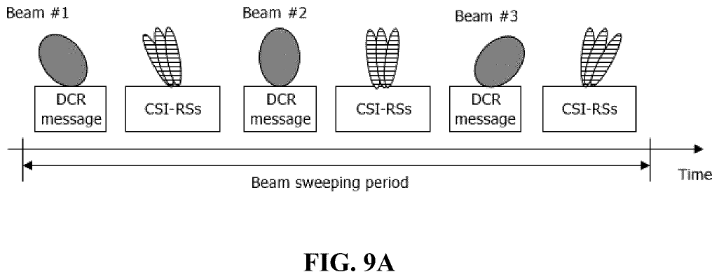

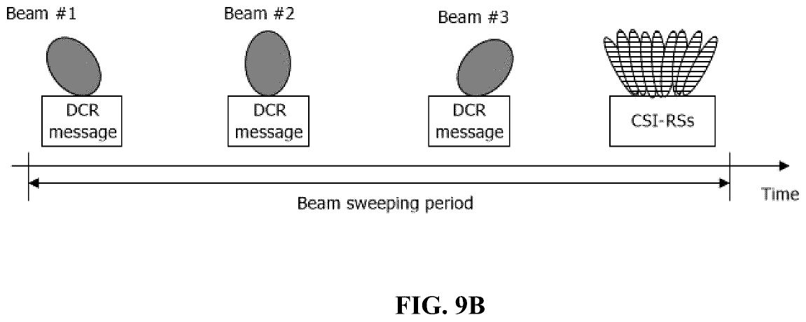

FIG. 9A and FIG. 9B Illustrate Examples of a DCR Message and CSI-RS being Transmitted within a Beam Sweeping Period According to an Embodiment of the Present Specification.

Unlike the method of transmitting together with an RS in an SL slot including a PSCCH and a PSSCH that transmit a DCR message as in FIG. 8, an additional RS signal may be transmitted together when transmitting a DCR message as in FIG. 9A and FIG. 9B. FIG. 9A assumes that three DCR messages are transmitted via beam sweeping within a beam sweeping period. And, it is an example where the location of a CSI-RS transmission resource is configured/fixed and operated by setting a time and frequency resource offset value based on the time and frequency resource location of each DCR message transmission. The offset value of the time/frequency resource where the CSI-RS is transmitted based on the DCR message transmission resource location or the setting for a specific time/frequency resource location may be fixedly set system-wise, and may be indicated via the DCR message or the MIB of an S-SSB. Alternatively, it may be indicated via RRC/MAC-CE, etc. This configuration may be set and operated in an SL-specific or resource pool-specific form. In the example of FIG. 9A, the transmission beam of the DCR message may be configured with a beam having a wider beam width compared to the CSI-RS transmission beam.

Furthermore, the CSI-RS beam transmitted after each DCR message may be set and used as a narrow beam within the S-SSB transmission beam width immediately before the CSI-RS transmission. FIG. 9A shows an example where a CSI-RS is configured with 3 symbols and operated, and shows an example where the CSI-RS transmitted through each symbol is transmitted with a different beam. The size of the resource for transmitting the CSI-RS, for example, the number of symbols or slots used, may be indicated via an MIB or RRC/MAC-CE, etc., and may be configured and operated in an SL-specific or resource pool-specific form. According to the example of FIG. 9A, after UE2 successfully receives a specific DCR message, it may acquire beam pairing information through the successfully received DCR message and the CSI-RSs transmitted thereafter.

FIG. 9B assumes that three DCR messages are transmitted via beam sweeping within a beam sweeping period. Unlike FIG. 9A, it is an example where CSI-RSs are transmitted consecutively after all DCR messages have been transmitted via beam sweeping. The CSI-RS transmission resource in FIG. 9B may be configured and operated in the same way as described in FIG. 9a. However, the CSI-RS in FIG. 9B shows an example of being transmitted with 9 different beams using 9 symbols. After successfully receiving a specific DCR message, UE2 may acquire beam pairing information through the successfully received DCR message and the CSI-RSs transmitted thereafter.

Some or all of the CSI-RS transmission beams described in FIG. 9A and FIG. 9B may be transmitted with the same beam, and the CSI-RSs transmitted with the same beam may be utilized for measurement purposes for setting the receive beam of UE2.

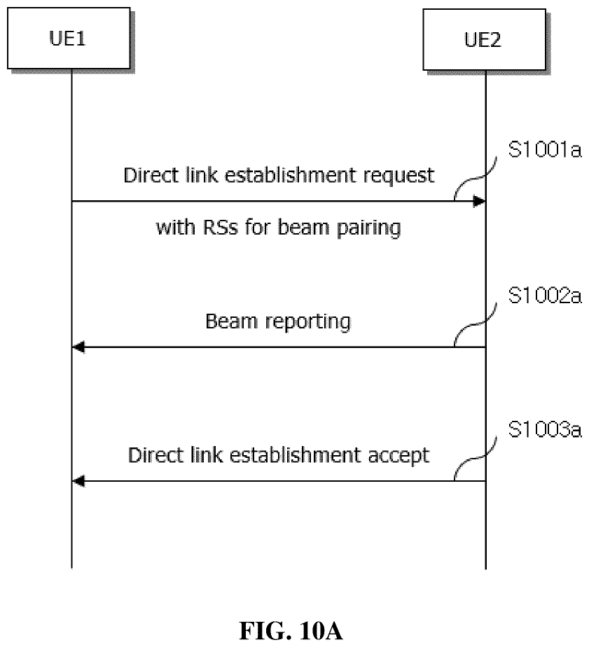

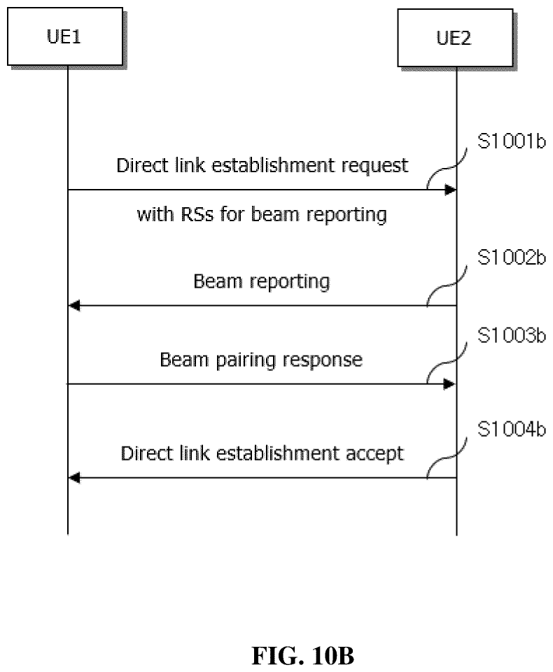

### FIG. 10A and FIG. 10A are Another Examples of Signaling for Performing Initial Beam Pairing and Unicast Link Establishment According to an Embodiment of the Present Specification.

FIG. 10A and FIG. 10B are examples of performing initial beam pairing and unicast link establishment, which are different forms from FIG. 6 described above. In FIG. 10A, UE2 receives a DCR message and RSs (S1001a), acquires beam information through this reception process, and performs beam reporting for beam information transfer using a specific beam or a specific resource based on the acquired beam information (S1002a). Thereafter, since the initial beam pairing is complete, UE2 transmits a DCA message using the corresponding beam pair and UE1 receives the DCA message (S1003a) to complete the unicast link establishment.

FIG. 10B is an example of a method where, after the beam reporting of UE2 in FIG. 10A, UE1 transmits a beam pairing response message to UE2 indicating that initial beam pairing is complete (S1003b), and after receiving the response message, UE2 sends a DCA message (S1004b) to complete the unicast link establishment. For reference, S1001b and S1002b of FIG. 10b are signalings corresponding to S1001a and S1002a of FIG. 10A, respectively, and may correspond to the content of FIG. 10A described above.

The DCR message transmission method proposed in FIG. 6, FIG. 10A, and FIG. 10B of this specification may be applied in a simple, extended, and/or modified form.

In the procedures of FIG. 6, FIG. 10A, and FIG. 10B of this specification, a timer (e.g., T5000) for performing unicast link establishment may be applied and operated. The timer may start at the time of the first DCR message transmission. And, the beam sweeping transmission of all DCR messages and the DCA message transmission of UE2 may be configured and operated to be completed before the timer (e.g., T5000) expires.

In the operation of the procedures of FIG. 10A and FIG. 10B, UE2 may be operated to transmit beam reporting within a specific time offset from the time when the DCR message and RS transmission of UE1 ends. For example, because the beam information measured by UE2 may no longer be valid due to channel changes over time after the RS and DCR message transmission for beam pairing by UE1, UE2 may perform beam reporting based on the acquired beam-related information within a specific time offset after the RS and DCR message transmission for beam pairing. If UE2 performs beam reporting after a specific time offset, the information of the corresponding beam pair may be discarded and not used by UE1. Furthermore, if UE1 fails to receive the beam reporting within a specific time offset, UE1 may again transmit the RS and DCR messages for beam pairing.

In the operation of the procedures of FIG. 10A and/or FIG. 10B, it may be operated to transmit a DCA message within a specific time offset after the beam reporting of UE2. For example, because the beam pair acquired by beam pairing may no longer be valid due to channel changes over time, the DCA message may be transmitted using the beam pair acquired through the beam pairing procedure within a specific time offset after beam reporting. If a DCA message is not received within the time offset, UE1 may again perform beam sweeping transmission of the DCR message and RS.

In the operation of the procedure of FIG. 10B, if UE2 does not receive a beam pairing response within a specific time offset after transmitting the beam reporting, it may not attempt to transmit a DCA message, but may attempt to receive the DCR message and RS for initial beam pairing with UE1. Alternatively, even if a beam response is not received after transmitting the beam reporting, UE2 may attempt to transmit a DCA message a configured number of times. The number of times may be 1 or a greater value. Alternatively, it may attempt to transmit a DCA message until a timer (e.g., T5000) expires. Thereafter, if the unicast link establishment fails, UE1 may perform the unicast link establishment and initial beam pairing procedures again.

Furthermore, in the operation of the procedure of FIG. 10B, UE1 may be configured and operated to receive a DCA message within a specific time offset after transmitting the beam pairing response. If the specific time offset is exceeded, UE1 may perform the unicast link establishment and initial beam pairing procedures again.

The specific time offset values, the number of DCA message transmission attempts, etc., described above may be used as fixed values in the system, or may be configured and operated as resource pool specific or SL specific. When a specific time offset value is configured, the offset value may be set using signalings available in the corresponding procedure. For example, it may be set via a DCR message, an MIB transmitted through the PSBCH of an S-SSB, a SIB, the SCI of a PSCCH, a PSSCH, a PSFCH, a MAC-CE, RRC, etc.

Furthermore, the transmission of the DCR message in a beam sweeping manner within the beam sweeping period described so far may be applied to the transmission of the DCA message in the same way.

Hereinafter, an apparatus to which the present specification may be applied will be described.

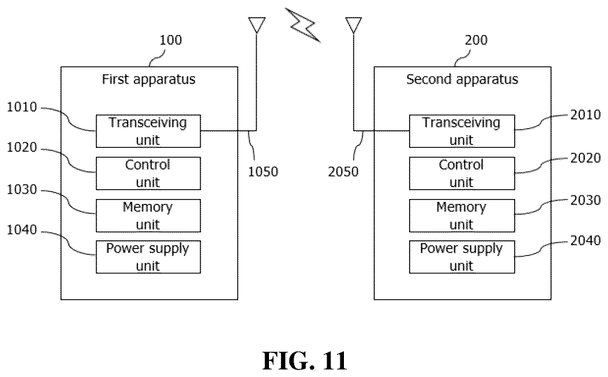

### FIG. 11 Illustrates a Wireless Communication Apparatus According to an Embodiment of the Present Specification.

Referring to FIG. 11, a wireless communication system may include a first apparatus (100) and a second apparatus (200).

The first apparatus (100) may be a base station, a network node, a transmitting terminal, a receiving terminal, a wireless device, a wireless communication device, a vehicle (e.g., a vehicle equipped with autonomous driving functions, a Connected Car), an Unmanned Aerial Vehicle (UAV), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a fintech device (or financial device), a security device, a climate/environmental device, a device related to 5G services, or a device related to other fields of the Fourth Industrial Revolution.

The second apparatus (200) may be a base station, a network node, a transmitting terminal, a receiving terminal, a wireless device, a wireless communication device, a vehicle (e.g., a vehicle equipped with autonomous driving functions, a Connected Car), an Unmanned Aerial Vehicle (UAV), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a fintech device (or financial device), a security device, a climate/environmental device, a device related to 5G services, or a device related to other fields of the Fourth Industrial Revolution.

The first apparatus (100) may include at least one processor such as a control unit (1020), at least one memory such as a memory unit (1030), and at least one transceiver such as a transceiver unit (1010). It may further include a power supply unit (1040) for supplying and controlling power to the control unit (1020), the memory unit (1030), and/or the transceiver unit (1010). The control unit (1020) may perform the functions, procedures, and/or methods described above. The control unit (1020) may execute one or more protocols. For example, the control unit (1020) may execute one or more layers of a wireless interface protocol. The memory unit (1030) is connected to the control unit (1020) and may store various types of information and/or instructions. The transceiver unit (1010) is connected to the control unit (1020) and may be controlled to transmit and receive wireless signals.

The second apparatus (200) may include at least one processor such as a control unit (2020), at least one memory such as a memory unit (2030), and at least one transceiver such as a transceiver unit (2010). It may further include a power supply unit (2040) for supplying and controlling power to the control unit (2020), the memory unit (2030), and/or the transceiver unit (2010). The control unit (2020) may perform the functions, procedures, and/or methods described above. The control unit (2020) may execute one or more protocols. For example, the control unit (2020) may execute one or more layers of a wireless interface protocol. The memory unit (2030) is connected to the control unit (2020) and may store various types of information and/or instructions. The transceiver unit (2010) is connected to the control unit (2020) and may be controlled to transmit and receive wireless signals.

The memory unit (1030) and/or the memory unit (2030) may be connected internally or externally to the control unit (1020) and/or the control unit (2020), respectively, and may also be connected to other control units through various technologies such as wired or wireless connections.

The first apparatus (100) and/or the second apparatus (200) may have one or more antennas. For example, the antenna (1050) and/or the antenna (2050) may be configured to transmit and receive wireless signals.

While preferred embodiments have been exemplarily described above, the disclosure of this specification is not limited to these specific embodiments, and thus may be modified, changed, or improved in various forms within the spirit of this specification and the scope described in the claims.

What is claimed is:

1. A method for a transmitting terminal to perform sidelink communication, the method comprising:
transmitting a direct link establishment request (DCR) message; and
receiving a direct link establishment accept (DCA) message in response to the transmitted DCR message,
wherein the DCR message is transmitted together with a reference signal (RS) for beam pairing, and
wherein at least one of the DCR message and the DCA message is repeated within a predetermined period.

2. The method of claim 1, further comprising:
receiving beam reporting based on the transmitted RS.

3. The method of claim 2, further comprising:
transmitting a beam pairing response, wherein the beam pairing response is transmitted before receiving the DCA message.

4. The method of claim 2, wherein the beam reporting is received based on a first predetermined time offset.

5. The method of claim 2, wherein the DCA message is received based on a second predetermined time offset.

6. The method of claim 1, wherein the RS comprises at least one of a sidelink synchronization signal block (S-SSB), a sidelink channel state information-reference signal (CSI-RS), or a demodulation reference signal (DM-RS) of a sidelink channel.

7. The method of claim 1, wherein the RS is repeatedly transmitted together with the DCR message within the predetermined period.

8. A method for a receiving terminal to perform sidelink communication, the method comprising:
receiving a direct link establishment request (DCR) message; and
transmitting a direct link establishment accept (DCA) message in response to the received DCR message,
wherein the DCR message is received together with a reference signal (RS) for beam pairing, and
wherein at least one of the DCR message and the DCA message is repeated within a predetermined period.

9. The method of claim 8, further comprising:
transmitting beam reporting based on the received RS.

10. The method of claim 9, further comprising:
receiving a beam pairing response, wherein the beam pairing response is received before transmitting the DCA message.

11. The method of claim 9, wherein the beam reporting is transmitted based on a first predetermined time offset.

12. The method of claim 9, wherein the DCA message is received based on a second predetermined time offset.

13. The method of claim 8, wherein the RS comprises at least one of a sidelink synchronization signal block (S-SSB), a sidelink channel state information-reference signal (CSI-RS), or a demodulation reference signal (DM-RS) of a sidelink channel.

14. The method of claim 8, wherein the RS is repeatedly received together with the DCR message within the predetermined period.

15. A transmitting terminal for performing sidelink communication, comprising:
a control unit; and
a memory unit storing instructions and operably and electrically connectable to the control unit, wherein operations performed based on the instructions being executed by the control unit comprise:
transmitting a direct link establishment request (DCR) message, and
receiving a direct link establishment accept (DCA) message in response to the transmitted DCR message,
wherein the DCR message is transmitted together with a reference signal (RS) for beam pairing, and
wherein at least one of the DCR message and the DCA message is repeated within a predetermined period.

16. The transmitting terminal of claim 15, wherein the operations performed based on the instructions being executed by the control unit further comprise:
receiving beam reporting based on the transmitted RS.

17. The transmitting terminal of claim 16, wherein the operations performed based on the instructions being executed by the control unit further comprise:
transmitting a beam pairing response, wherein the beam pairing response is transmitted before receiving the DCA message.

18. A receiving terminal for performing sidelink communication, comprising:
a control unit; and
a memory unit storing instructions and operably and electrically connectable to the control unit, wherein operations performed based on the instructions being executed by the control unit comprise:
receiving a direct link establishment request (DCR) message, and
transmitting a direct link establishment accept (DCA) message in response to the received DCR message,
wherein the DCR message is received together with a reference signal (RS) for beam pairing, and
wherein at least one of the DCR message and the DCA message is repeated within a predetermined period.

19. The receiving terminal of claim 18, wherein the operations performed based on the instructions being executed by the control unit further comprise:
transmitting beam reporting based on the received RS.

20. The receiving terminal of claim 19, wherein the operations performed based on the instructions being executed by the control unit further comprise:
receiving a beam pairing response, wherein the beam pairing response is received before transmitting the DCA message.
